(19) United States
(12) Patent Application Publication
(10) Pub. No.: US 2026/0225226 A1
(43) Pub. Date: Aug. 6, 2026

(54) TENSEGRITY ROBOT WITH SHAPE MEMORY ALLOYS SPRINGS AND RELATED METHODS

(71) Applicant: ANKAN DAS, Oviedo, FL (US)

(72) Inventor: ANKAN DAS, Oviedo, FL (US)

(21) Appl. No.: 19/466,829

(22) Filed: Feb. 2, 2026

Related U.S. Application Data
(60) Provisional application No. 63/752,176, filed on Jan. 31, 2025.

(51) Int. Cl. B25J 9/00; B25J 9/08; B25J 9/10; B25J 19/00

(52) U.S. Cl. CPC B25J 9/0009; B25J 9/08; B25J 9/1085; B25J 19/0025

(57) ABSTRACT

A tensegrity robot includes rods arranged to define a tensegrity structure. Each rod has a first end and a second end opposing the first end. The tensegrity robot also includes fixed elastic members coupled between adjacent first and second ends of the rods within the tensegrity structure, each fixed elastic member having a fixed elastic constant. The tensegrity robot also includes SMA springs coupled between adjacent first and second ends of the rods within the tensegrity structure, and a control unit carried by the tensegrity structure and coupled to the SMA springs. The control unit is configured to selectively apply a voltage to one or more of the SMA springs to cause the tensegrity structure to move.

### RELATED APPLICATION

This application is based upon prior filed copending Application No. 63/752,176 filed Jan. 31, 2025, the entire subject matter of which is incorporated herein by reference in its entirety.

### TECHNICAL FIELD

The present disclosure relates to the field of robotics, and, more particularly, to a tensegrity robot and related methods.

### BACKGROUND

Tensegrity structures are architectural systems composed of rigid compressive elements, such as rods, suspended within a network of tensile elements, such as cables or springs, where the compressive elements do not touch each other, and stability is maintained through balanced tension. These structures are known for their lightweight construction, resilience to impacts, and ability to distribute loads efficiently. In robotics, tensegrity designs have been explored for creating flexible, adaptable robots that can navigate uneven terrain or absorb shocks, unlike traditional rigid-bodied robots which are often heavy and prone to failure in dynamic environments.

However, typical tensegrity robots typically rely on passive tension elements or external actuators like motors, which add weight, complexity, and power consumption. For example, some existing systems use vibrating motors or pneumatic actuators, limiting portability and efficiency. These limitations hinder applications in remote or space-constrained scenarios, such as planetary exploration or disaster response, where lightweight, low-power actuation is critical.

### SUMMARY

Generally, a tensegrity robot comprises a plurality of rods arranged to define a tensegrity structure. Each rod comprises a first end and a second end opposing the first end. The tensegrity robot also comprises a plurality of fixed elastic members coupled between adjacent first and second ends of the plurality of rods within the tensegrity structure. Each fixed elastic member has a fixed elastic constant. The tensegrity robot also includes a plurality of shape memory alloy (SMA) springs coupled between adjacent first and second ends of the plurality of rods within the tensegrity structure, and a control unit carried by the tensegrity structure and coupled to the plurality of SMA springs. The control unit is configured to selectively apply a voltage to at least one SMA spring from the plurality of SMA springs to cause the tensegrity structure to move.

In particular, the plurality of SMA springs may be coupled to each and every of the first and second ends of the plurality of rods. For example, each of the plurality of fixed elastic members may comprise a rubber band elastic member. Each of the first end and the second end may comprise first and second arms defining a slot therebetween, the slot receiving a respective fixed elastic member, and first and second transverse arms extending outwardly therefrom and to receive a respective SMA spring.

Also, the control unit may comprise a controller coupled to the plurality of SMA springs, and a battery power source coupled to the controller. The control unit may also comprise a wireless transceiver coupled to the controller and the battery power source and configured to communicate with a mobile device, a plurality of switches coupled to the plurality of SMA springs, and a relay switch coupled between the battery power source and the controller. The plurality of SMA springs may comprise a plurality of SMA spring groups, each SMA spring group defining a rhombus shaped portion of the tensegrity structure.

Another aspect is directed to a method for making a tensegrity robot. The method comprises positioning a plurality of rods arranged to define a tensegrity structure. Each rod comprises a first end and a second end opposing the first end. The method also comprises coupling a plurality of fixed elastic members between adjacent first and second ends of the plurality of rods within the tensegrity structure. Each fixed elastic member has a fixed elastic constant. The method also comprises coupling a plurality of SMA springs between adjacent first and second ends of the plurality of rods within the tensegrity structure, and coupling a control unit to be carried by the tensegrity structure and to the plurality of SMA springs. The control unit is configured to selectively apply a voltage to at least one SMA spring from the plurality of SMA springs to cause the tensegrity structure to move.

### BRIEF DESCRIPTION OF THE DRAWINGS

FIG. 1 is a perspective view of a tensegrity robot, according to an example embodiment of the present disclosure.

FIG. 2 is a side view of the tensegrity robot of FIG. 1 without the control unit.

FIG. 3 is a top plan view of first and second ends of a rod from the tensegrity robot of FIG. 1.

FIG. 4 is a schematic view of the control unit from the tensegrity robot of FIG. 1.

FIGS. 5A & 5B are a circuit diagram of the control unit and SMA springs from the tensegrity robot of FIG. 1.

FIGS. 6A & 6B are diagrams of contraction time and length respectively in an example embodiment of tensegrity robot of FIG. 1 with low strength tensegrity and large SMA springs.

FIGS. 7A & 7B are diagrams of contraction time and length respectively in an example embodiment of tensegrity robot of FIG. 1 with low strength tensegrity and small SMA springs.

FIGS. 8A & 8B are diagrams of contraction time and length respectively in an example embodiment of tensegrity robot of FIG. 1 with high strength tensegrity and large SMA springs.

FIGS. 9A & 9B are diagrams of power per step and energy per step respectively in an example embodiment of tensegrity robot of FIG. 1.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout.

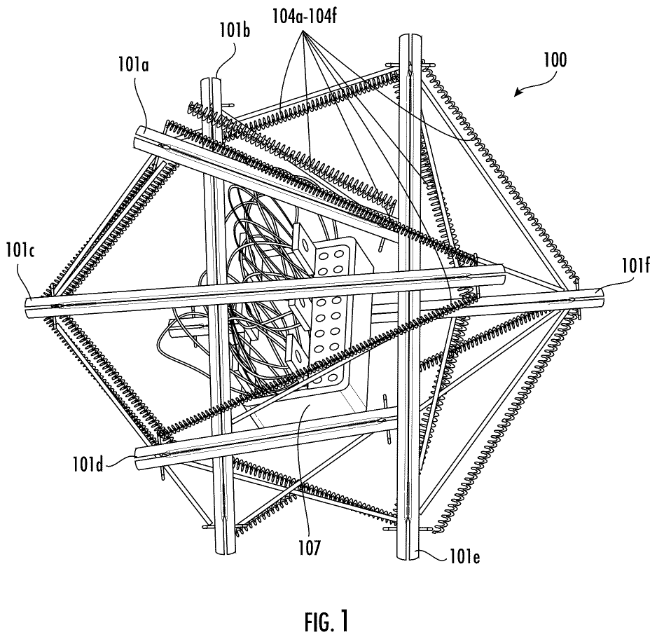

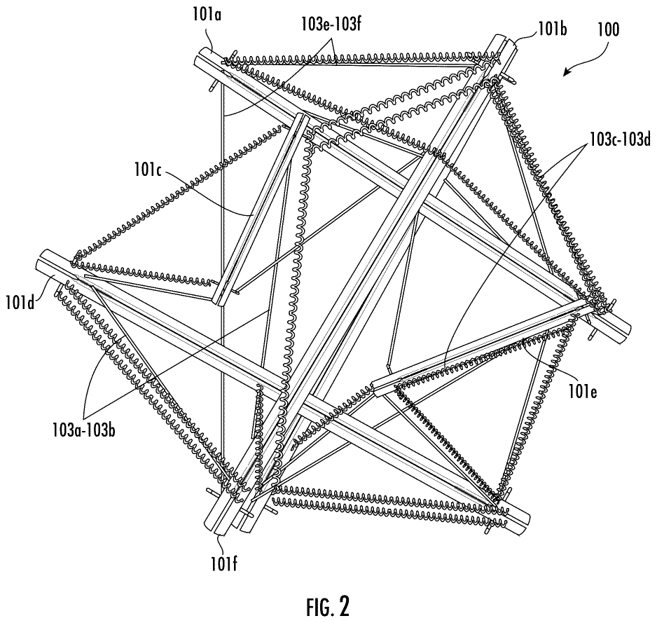

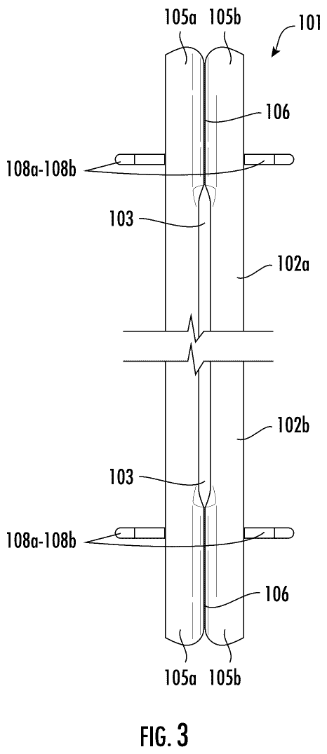

Referring now to FIGS. 1-3, a tensegrity robot 100 according to the present disclosure is now described. The tensegrity robot 100 comprises a plurality of rods 101a-101f arranged to define a tensegrity structure. In the illustrated embodiment, the tensegrity structure comprises 6 rods, but in other embodiments, a different number of rods can be used to create varying tensegrity structures.

Each rod of the plurality of rods 101a-101f comprises a first end 102a and a second end 102b opposing the first end. Each rod of the plurality of rods 101a-101f is made from a material with sufficient mechanical strength to satisfy the structural requirements of the tensegrity structure (i.e., exceeding threshold amount of flexural modulus), for example, cellulose composite, cellulose, carbon fiber, polymer, metal, etc.

The tensegrity robot 100 illustratively comprises a plurality of fixed elastic members 103a-103f coupled between adjacent first and second ends 102a-102b of the plurality of rods 101a-101f within the tensegrity structure. In other words, each fixed elastic member 103a-103f has a fixed elastic characteristic, which may only degrade gradually only due to material fatigue from use. Each fixed elastic member 103a-103f has a fixed elastic constant. For example, each of the plurality of fixed elastic members 103a-103f illustratively includes a rubber band elastic member. Of course, other fixed elastic members may be used, such as a typical coil spring.

The tensegrity robot 100 illustratively comprises a plurality of SMA springs 104a-104x (e.g., the illustrated 24) coupled between adjacent first and second ends 102a-102b of the plurality of rods 101a-101f within the tensegrity structure. For example, each of the plurality of SMA springs 104a-104x may comprise a NiTi SMA coil spring having a 3.45 mm spring diameter, 0.51 mm wire diameter, 40 coils, and a 90° C. transition temperature. In particular, the plurality of SMA springs 104a-104x are illustratively coupled to each and every of the first and second ends 102a-102b of the plurality of rods 101a-101f.

As perhaps best seen in FIG. 3, each of the first end 102a and the second end 102b illustratively comprises first and second arms 105a-105b defining a slot 106 therebetween. Each slot 106 is to receive a respective fixed elastic member 103a-103f. Also, each of the first end 102a and the second end 102b illustratively comprises first and second transverse arms 108a-108b (e.g., eye screw with round opening for receiving the distal ends of the SMA springs) extending outwardly therefrom and to receive a distal end of a respective SMA spring 104a-104x.

The tensegrity robot 100 illustratively comprises a control unit 107 carried internally by the tensegrity structure and coupled to the plurality of SMA springs 104a-104x. The control unit 107 is configured to selectively apply a voltage to one or more SMA springs 104a-104x from the plurality of SMA springs to cause the tensegrity structure to contort and move. Helpfully, the control unit 107 is compact and does not impact movement/deformation of the tensegrity structure.

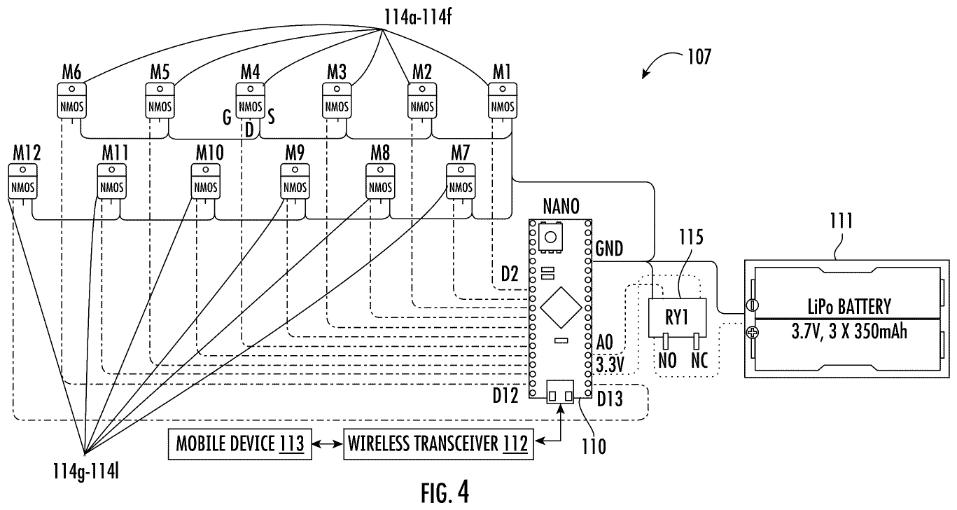

Referring now additionally to FIGS. 4 & 5A-5B, the control unit 107 illustratively includes a controller 110 coupled to the plurality of SMA springs 104a-104x, and a battery power source 111 coupled to the controller. The controller 110 may comprise logic circuitry, and in some embodiments, the controller may comprise an Arduino Nano 33 BLE Sense Rev2, as available from QUALCOMM Incorporated of San Diego, FL. The control unit 107 illustratively comprises a wireless transceiver 112 coupled to the controller 110 and the battery power source 111 and configured to communicate with a mobile device 113 (e.g., cellular device, tablet computing device). The wireless transceiver 112 may comprise one or more of a Bluetooth transceiver (e.g., Bluetooth Low Energy), a WiFi transceiver, or a low power radio frequency transceiver. Although depicted as a separate component, in some embodiments, the wireless transceiver 112 may be integrated with the controller 110, such as the embodiment with the Arduino Nano 33 BLE Sense Rev2.

The control unit 107 illustratively includes a plurality of switches 114a-1141 coupled to the plurality of SMA springs 104a-104x, the controller 110, and the battery power source 111. In the illustrated embodiment, each of the plurality of switches 114a-1141 comprises a MOSFET transistor. The control unit 107 also illustratively comprises a relay switch 115 coupled between the battery power source 111 and the controller 110. Further, the plurality of SMA springs 104a-104x are coupled in a plurality of SMA spring groups 116a-116f. Each SMA spring group 116a-116f defines a rhombus shaped portion of the tensegrity structure. In particular, each SMA spring group 116a-116f illustratively comprises first and second pairs of SMA springs 104a-104x coupled in parallel.

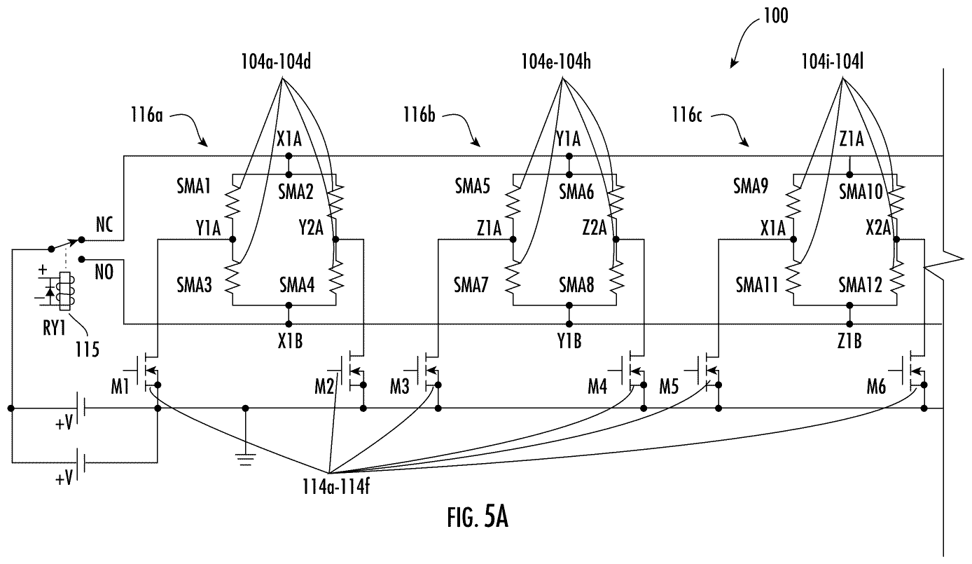

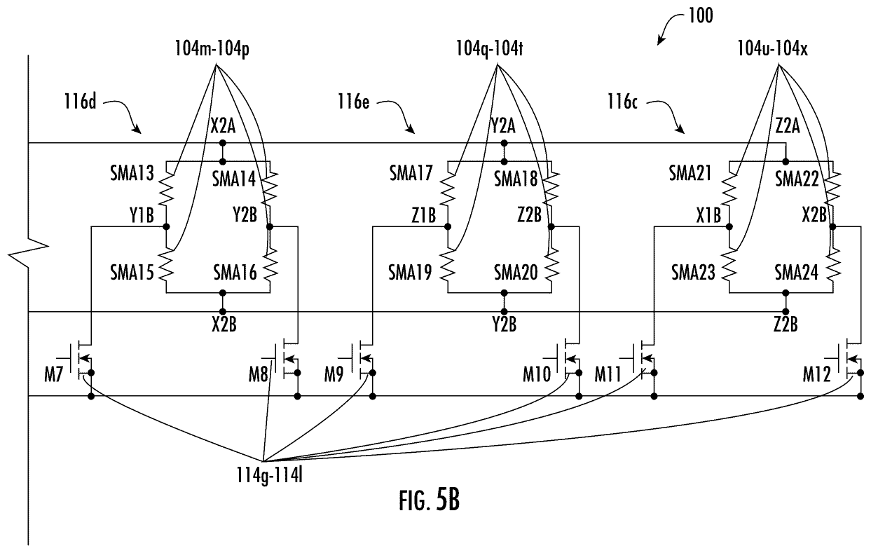

In FIGS. 5A-5B, each of the plurality of rods 101a-101f is labeled within the circuit diagram as X1, X2, Y1, Y2, Z1, Z2. The appended A and B respectively denotes first and second ends 102a-102b of a given rod 101a-101f. As will be appreciated, the illustrated configuration proves for flexible movement for the tensegrity structure.

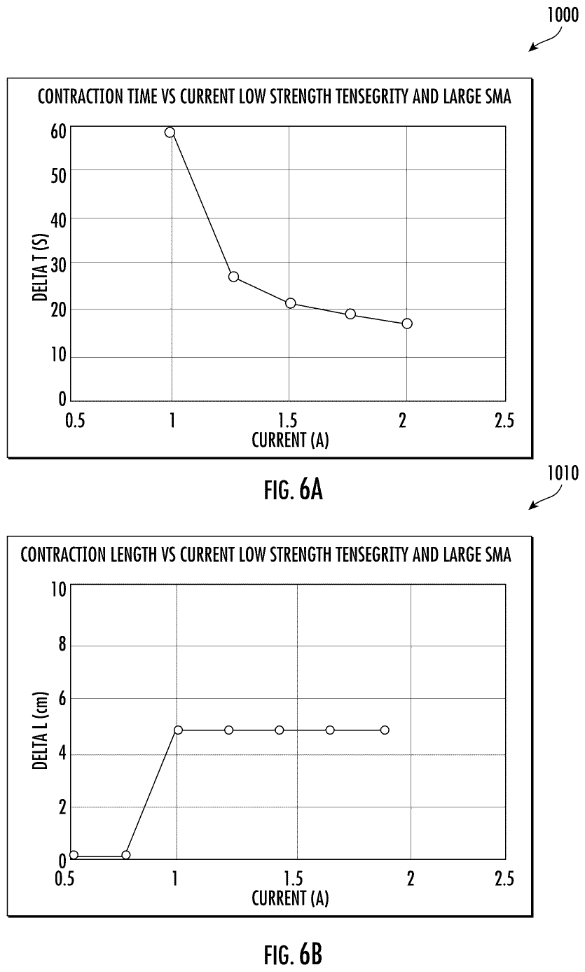

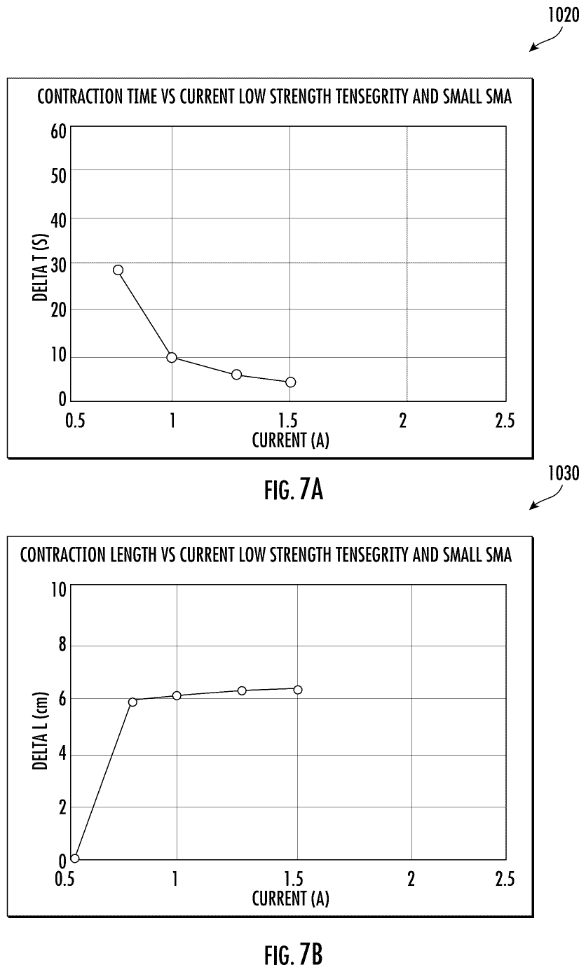

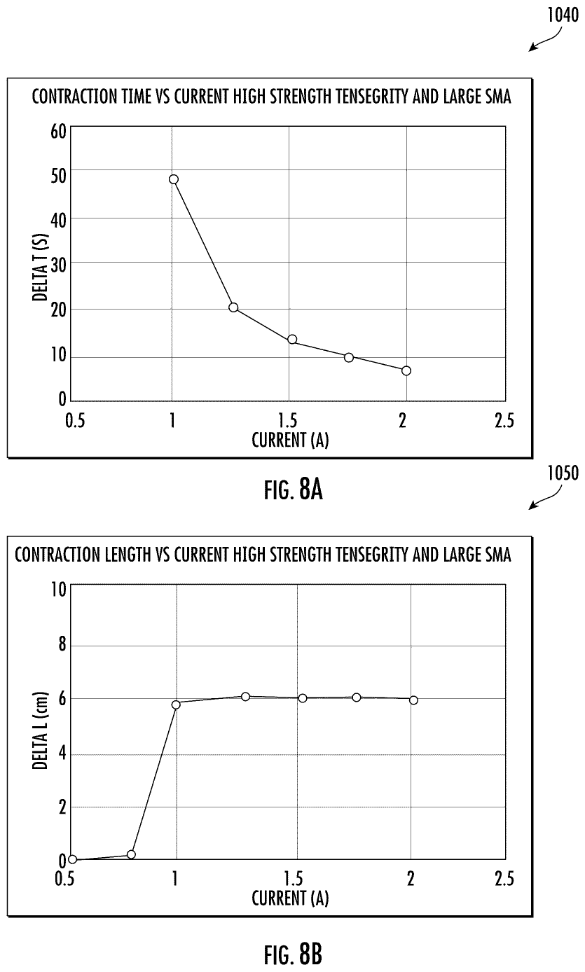

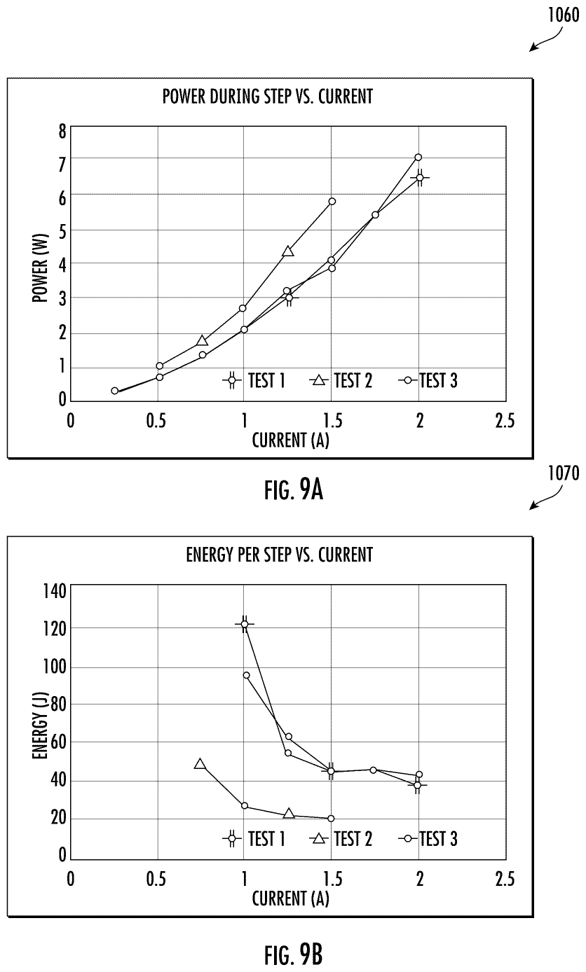

Referring now to FIGS. 6A-6B, 7A-7B, 8A-8B, & 9A-9B, diagrams 1000-1070 illustrate performance of an example embodiment of the tensegrity robot 100. For the large SMA spring 104a-104x results, a 3.45 mm spring diameter, 0.51 mm wire diameter, 30 coil, 90° C. transition temperature spring was used. For the small SMA spring 104a-104x results, a 2.54 mm spring diameter, 0.38 mm wire diameter, 40 coil, 90° C. transition temperature spring was used. Tensegrity strength represents the tension level in elastic elements. For example, high strength is 2× of low strength in these results. As will be appreciated, lower contraction time provides for faster stepping and greater robot speed. As shown, contraction time drops approximately exponentially over current. As shown, contraction length was negligible at low currents (i.e., prior to phase transition). Also, step change in contraction occurs after martensite to austenite transition at threshold current, and high tensegrity strength reduces steady contraction length with no change in threshold current. As apparent, it may be helpful to avoid high currents (i.e., >2.5 A) to prevent SMA spring 104a-104x damage.

In particular, diagrams 1060, 1070 show that power consumption by the SMA springs 104a-104x during a step increases approximately exponentially over current. Simultaneously, the per step energy consumption decreases approximately exponentially over current. This implies higher current is favorable for fast motion with low energy consumption per step. However, high current can damage SMAs (e.g., >2.5 A for large SMA). High and low strength tensegrity show similar power and energy characteristics, and high strength tensegrity has a slightly higher consumption. The small SMA has a lower consumption than large SMA for similar tensegrity tension.

In some example embodiments, the tensegrity robot 100 takes a step when one side of a closed base-triangle contracts (within the tensegrity structure) to approximately half of its undeformed length via actuation of respective SMA springs 104a-104x. The stepping of the tensegrity robot 100 may be governed by the formula:

$$N ( d + p ) < 0.5 {L}_{u}$$

where N is number of coils; d is the wire diameter; p is the pitch of the SMA; and Lᵤ is the undeformed length of each tensegrity element.

Another aspect is directed to a method for making a tensegrity robot 100. The method comprises positioning a plurality of rods 101a-101f arranged to define a tensegrity structure, each rod comprising a first end 102a and a second end 102b opposing the first end. The method also comprises coupling a plurality of fixed elastic members 103a-103f between adjacent first and second ends 102a-102b of the plurality of rods 101a-101f within the tensegrity structure, each fixed elastic member having a fixed elastic constant. The method also comprises coupling a plurality of SMA springs 104a-104x between adjacent first and second ends 102a-102b of the plurality of rods 101a-101f within the tensegrity structure, and coupling a control unit 107 to be carried by the tensegrity structure and to the plurality of SMA springs. The control unit 107 is configured to selectively apply a voltage to one or more SMA springs 104a-104x from the plurality of SMA springs to cause the tensegrity structure to move.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A tensegrity robot comprising:
a plurality of rods arranged to define a tensegrity structure, each rod comprising a first end and a second end opposing the first end;
a plurality of fixed elastic members coupled between adjacent first and second ends of the plurality of rods within the tensegrity structure, each fixed elastic member having a fixed elastic constant;
a plurality of shape memory alloy (SMA) springs coupled between adjacent first and second ends of the plurality of rods within the tensegrity structure; and
a control unit carried by the tensegrity structure and coupled to the plurality of SMA springs and configured to selectively apply a voltage to at least one SMA spring from the plurality of SMA springs to cause the tensegrity structure to move.

2. The tensegrity robot of claim 1 wherein the plurality of SMA springs is coupled to each and every of the first and second ends of the plurality of rods.

3. The tensegrity robot of claim 1 wherein each of the plurality of fixed elastic members comprises a rubber band elastic member.

4. The tensegrity robot of claim 1 wherein each of the first end and the second end comprises first and second arms defining a slot therebetween, the slot receiving a respective fixed elastic member.

5. The tensegrity robot of claim 1 wherein each of the first end and the second end comprises first and second transverse arms extending outwardly therefrom and to receive a respective SMA spring.

6. The tensegrity robot of claim 1 wherein the control unit comprises a controller coupled to the plurality of SMA springs, and a battery power source coupled to the controller.

7. The tensegrity robot of claim 6 wherein the control unit comprises a wireless transceiver coupled to the controller and the battery power source and configured to communicate with a mobile device.

8. The tensegrity robot of claim 6 wherein the control unit comprises a plurality of switches coupled to the plurality of SMA springs, and a relay switch coupled between the battery power source and the controller.

9. The tensegrity robot of claim 8 wherein the plurality of SMA springs comprises a plurality of SMA spring groups, each SMA spring group defining a rhombus shaped portion of the tensegrity structure.

10. A tensegrity robot comprising:
a plurality of rods arranged to define a tensegrity structure, each rod comprising a first end and a second end opposing the first end;
a plurality of rubber band elastic members coupled between adjacent first and second ends of the plurality of rods within the tensegrity structure, each rubber band elastic member having a fixed elastic constant;
a plurality of shape memory alloy (SMA) springs coupled between adjacent first and second ends of the plurality of rods within the tensegrity structure, the plurality of SMA springs being coupled to each and every of the first and second ends of the plurality of rods; and
a control unit carried by the tensegrity structure and coupled to the plurality of SMA springs and configured to selectively apply a voltage to at least one SMA spring from the plurality of SMA springs to cause the tensegrity structure to move.

11. The tensegrity robot of claim 10 wherein each of the first end and the second end comprises first and second arms defining a slot therebetween, the slot receiving a respective rubber band elastic member.

12. The tensegrity robot of claim 10 wherein each of the first end and the second end comprises first and second transverse arms extending outwardly therefrom and to receive a respective SMA spring.

13. The tensegrity robot of claim 10 wherein the control unit comprises a controller coupled to the plurality of SMA springs, and a battery power source coupled to the controller.

14. The tensegrity robot of claim 13 wherein the control unit comprises a wireless transceiver coupled to the controller and the battery power source and configured to communicate with a mobile device.

15. The tensegrity robot of claim 13 wherein the control unit comprises a plurality of switches coupled to the plurality of SMA springs, and a relay switch coupled between the battery power source and the controller.

16. The tensegrity robot of claim 15 wherein the plurality of SMA springs comprises a plurality of SMA spring groups, each SMA spring group defining a rhombus shaped portion of the tensegrity structure.

17. A method for making a tensegrity robot, the method comprising:
positioning a plurality of rods arranged to define a tensegrity structure, each rod comprising a first end and a second end opposing the first end;
coupling a plurality of fixed elastic members between adjacent first and second ends of the plurality of rods within the tensegrity structure, each fixed elastic member having a fixed elastic constant;
coupling a plurality of shape memory alloy (SMA) springs between adjacent first and second ends of the plurality of rods within the tensegrity structure; and
coupling a control unit to be carried by the tensegrity structure and to the plurality of SMA springs, the control unit configured to selectively apply a voltage to at least one SMA spring from the plurality of SMA springs to cause the tensegrity structure to move.

18. The method of claim 17 wherein the plurality of SMA springs is coupled to each and every of the first and second ends of the plurality of rods; wherein each of the plurality of fixed elastic members comprises a rubber band elastic member; wherein each of the first end and the second end comprises first and second arms defining a slot therebetween, the slot receiving a respective fixed elastic member; wherein each of the first end and the second end comprises first and second transverse arms extending outwardly therefrom and to receive a respective SMA spring; and wherein the control unit comprises a controller coupled to the plurality of SMA springs, and a battery power source coupled to the controller.

19. The method of claim 18 wherein the control unit comprises a wireless transceiver coupled to the controller and the battery power source and configured to communicate with a mobile device.

20. The method of claim 18 wherein the control unit comprises a plurality of switches coupled to the plurality of SMA springs, and a relay switch coupled between the battery power source and the controller.
